(19) United States
(12) Patent Application Publication
(10) Pub. No.: US 2025/0297077 A1
(43) Pub. Date: Sep. 25, 2025

(54) MANUFACTURING METHOD OF RECYCLED POLYESTER FABRIC

(71) Applicant: NAN YA PLASTICS CORPORATION, Taipei City (TW)

(72) Inventors: Ching-Yao Yuan, Taipei City (TW); Chung Yu Chen, Taipei City (TW); Zhang-Jian Huang, Taipei City (TW); Mong-Chen Chang, Taipei City (TW)

(73) Assignee: NAN YA PLASTICS CORPORATION, Taipei City (TW)

(21) Appl. No.: 18/631,031

(22) Filed: Apr. 9, 2024

(30) Foreign Application Priority Data
Mar. 20, 2024 (TW) 113110230

(51) Int. Cl. C08J 11/10; C08J 11/12

(52) U.S. Cl. CPC C08J 11/10; C08J 11/12; C08J 11/16; C08J 2367/02

(57) ABSTRACT

A manufacturing method of a recycled polyester fabric includes: providing a dope-dyed fabric; performing a pre-depolymerization step on the dope-dyed fabric; and performing a post-processing step on a pre-depolymer to obtain the recycled polyester fabric. The dope-dyed fabric includes a pigment and a polyethylene terephthalate resin, and a first particle size of the pigment is less than 1 micrometer. The pre-depolymerization step includes performing a first depolymerization procedure on the dope-dyed fabric to form an oligomer; adding the oligomer to an activated carbon to perform a mixing procedure; and performing a filtration procedure to separate the oligomer from the activated carbon and obtain the pre-depolymer. A second particle size of the activated carbon is larger than the first particle size of the pigment. The post-processing step includes a second depolymerization procedure, a monomer purification procedure, a polymerization procedure, or a combination thereof.

### CROSS-REFERENCE TO RELATED APPLICATION

This application claims the priority benefit of Taiwan application serial no. 113110230, filed on Mar. 20, 2024. The entirety of the above-mentioned patent application is hereby incorporated by reference herein and made a part of specification.

### BACKGROUND

### Technical Field

The disclosure relates to a manufacturing method of a recycled polyester fabric.

### Description of Related Art

In the current polyester fabric recycling technology, a pre-processing process such as solvent extraction is often used for decolorization to separate a dye from gaps between fabric fibers to achieve recycling. However, the processing manner cannot effectively separate a pigment with a smaller particle size dispersed in a resin of a dope-dyed polyester fabric (for example, filtration is more difficult or the pigment may easily adhere during a subsequent crystallization process), thereby causing yield to be too low.

### SUMMARY

The disclosure provides a manufacturing method of a recycled polyester fabric, which has good performance in yield and hue.

The disclosure provides a manufacturing method of a recycled polyester fabric, which includes providing a dope-dyed fabric; performing a pre-depolymerization step on the dope-dyed fabric; and performing a post-processing step on a pre-depolymer to obtain the recycled polyester fabric. The dope-dyed fabric includes a pigment and a polyethylene terephthalate resin, and a first particle size of the pigment is less than 1 micrometer. The pre-depolymerization step includes performing a first depolymerization procedure on the dope-dyed fabric to form an oligomer; adding the oligomer to an activated carbon to perform a mixing procedure; and performing a filtration procedure to separate the oligomer from the activated carbon and obtain a pre-depolymer. A second particle size of the activated carbon is larger than the first particle size of the pigment. The post-processing step includes a second depolymerization procedure, a monomer purification procedure, a polymerization procedure, or a combination thereof.

In an embodiment of the disclosure, the second particle size of the activated carbon is greater than 1 micrometer and less than or equal to 100 micrometers.

In an embodiment of the disclosure, a weight percentage of the pigment in the dope-dyed fabric is between 1 wt % and 10 wt %.

In an embodiment of the disclosure, a weight ratio of the activated carbon to the oligomer is between 0.005 and 0.3.

In an embodiment of the disclosure, an execution temperature of the mixing procedure is between 110° C. and 190° C.

In an embodiment of the disclosure, an execution time of the mixing procedure is between 5 minutes and 90 minutes.

In one embodiment of the disclosure, the first depolymerization procedure includes using ethylene glycol and a catalyst.

In an embodiment of the disclosure, a weight ratio of the catalyst to the dope-dyed fabric is between 0.001 and 0.1.

In an embodiment of the disclosure, an execution temperature of the first depolymerization procedure is between 180° C. and 220° C.

In an embodiment of the disclosure, an execution time of the first depolymerization procedure is between 5 minutes and 120 minutes.

Based on the above, the disclosure introduces the pre-depolymerization step, so that the activated carbon with the large particle size and the pigment with the small particle size are aggregated and agglomerated. In this way, the pigment and the resin can be effectively separated through the filtration procedure, and the efficiency of the post-processing step can be increased, thereby having good performance in both yield and hue.

In order for the features and advantages of the disclosure to be more comprehensible, the following specific embodiments are described in detail in conjunction with the drawing.

### BRIEF DESCRIPTION OF THE DRAWINGS

FIG. 1s a partial flow schematic diagram of a manufacturing method of a recycled polyester fabric according to an embodiment of the disclosure.

### DESCRIPTION OF THE EMBODIMENTS

In the following detailed description, for purposes of illustration and not limitation, exemplary embodiments disclosing specific details are set forth in order to provide a thorough understanding of various principles of the disclosure. However, it will be apparent to persons of ordinary skill in the art that the disclosure may be practiced in other embodiments that depart from the specific details disclosed herein, having the benefit of the disclosure. Moreover, the description of conventional devices, methods, and materials may be omitted so as not to obscure the description of the various principles of the disclosure.

The disclosure will be described more fully with reference to the drawing of the embodiment. However, the disclosure may also be embodied in various forms and should not be limited to the embodiment described herein.

Unless otherwise defined, all terms (including technical and scientific terms) used herein have the same meaning as commonly understood by persons of ordinary skill in the art to which the disclosure belongs.

The term “between” used in the specification to define a value range is intended to cover a range equal to and between the stated endpoint values. For example, a size range between a first value and a second value means that the size range may cover the first value, the second value, and any value between the first value and the second value.

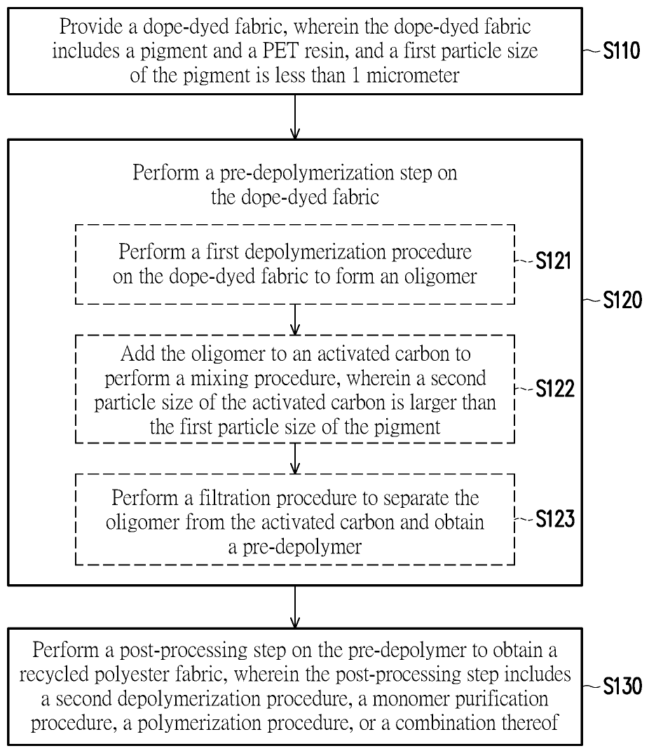

FIG. 1s a partial flow schematic diagram of a manufacturing method of a recycled polyester fabric according to an embodiment of the disclosure.

Please refer to FIGURE. The manufacturing method of the recycled polyester fabric of the embodiment includes at least the following steps. First, as shown in Step S110, a dope-dyed fabric is provided, wherein the dope-dyed fabric includes a pigment and a polyethylene terephthalate (PET) resin, and a first particle size of the pigment is less than 1 micrometer. In some embodiments, the first particle size of the pigment is an average particle size

and may be greater than or equal to 0.003 micrometers, and the pigment includes carbon black or the like, but the disclosure is not limited thereto.

In some embodiments, a weight percentage of the pigment in the dope-dyed fabric is between 1 wt % and 10 wt %, and a weight percentage of the resin in the dope-dyed fabric is between 89 wt % and 99 wt %. Within the aforementioned percentage ranges, if the pigment and the resin cannot be effectively separated, there will be a negative impact on efficiency of subsequent depolymerization, thereby affecting yield. Therefore, within the aforementioned percentage ranges, adopting the manufacturing method of the recycled polyester fabric of the embodiment can have more advantages, but the disclosure is not limited thereto.

In some embodiments, the dope-dyed fabric is composed of the pigment and the polyethylene terephthalate resin, that is, the sum of the weight percentage of the pigment in the dope-dyed fabric and the weight percentage of the resin in the dope-dyed fabric is 100 wt %, but the disclosure is not limited thereto.

It should be noted that the embodiment does not limit the specific type of the dope-dyed fabric. As long as the dope-dyed fabric is a waste dope-dyed fabric that needs to be recycled and is produced by dispersing a appropriate pigment in a appropriate polyester resin and then spinning, the same belongs to the protection scope of the disclosure.

Next, as shown in Step S120, a pre-depolymerization step is performed on the dope-dyed fabric, wherein in the embodiment, the pre-depolymerization step may be performed through Step S121, Step S122, and Step S123. Furthermore, as shown in Step S121, a first depolymerization procedure is performed on the dope-dyed fabric to form an oligomer. Then, as shown in Step S122, the oligomer is added to an activated carbon to perform a mixing procedure, wherein a second particle size of the activated carbon is larger than the first particle size of the pigment. Finally, as shown in Step S123, a filtration procedure is performed to separate the oligomer from the activated carbon and obtain a pre-depolymer.

Accordingly, the embodiment introduces the pre-depolymerization step, so that the activated carbon with the large particle size and the pigment with the small particle size are aggregated and agglomerated. In this way, the pigment and the resin can be effectively separated through the filtration procedure, and the efficiency of a post-processing step can be increased, thereby having good performance in both yield and hue.

Furthermore, after the nanoscale pigment (less than 1 micrometer) is aggregated and agglomerated using the aforementioned manner, the particle size can be increased to more than 1 micrometer. In this way, an appropriate filtration manner may be used to separate the pigment, and after removing the pigment, the efficiency of a post-processing process (for example, a second depolymerization procedure, crystallization purification, etc.) can be improved to improve yield and hue. In addition, the activated carbon may be further used as a fuel rod to recover heat energy after the filtration procedure. Therefore, using the activated carbon to separate the pigment in the pre-depolymerization step can also have advantages such as easy waste disposal and low carbon footprint.

After performing the filtration procedure, as shown in Step S130, the post-processing step is performed on the pre-depolymer to obtain the recycled polyester fabric, wherein the post-processing step includes the second depolymerization procedure, a monomer purification procedure, a polymerization procedure, or a combination thereof.

The specific details of different procedures in each of the above steps will be sequentially exemplified below.

### <First Depolymerization Procedure>

In some embodiments, an execution temperature of the first depolymerization procedure is between 180° C. and 220° C. For example, the execution temperature may be between 190° C. and 210° C. to have improved depolymerization efficiency and hue.

In some embodiments, an execution time of the first depolymerization procedure is between 5 minutes and 120 minutes. For example, the execution time may be between 10 minutes and 90 minutes.

In some embodiments, the first depolymerization procedure includes using ethylene glycol (EG) and a catalyst, wherein the catalyst includes an organic metal, and the organic metal is, for example, zinc acetate, organic titanium, organic antimony, organic aluminum, an ionic liquid, or a combination thereof.

In some embodiments, a weight ratio of ethylene glycol to the dope-dyed fabric (ethylene glycol/dope-dyed fabric) when feeding in the first depolymerization procedure is between 2 and 10. For example, the weight ratio may be between 3 and 8.

In some embodiments, a weight ratio of the catalyst to the dope-dyed fabric (catalyst/dope-dyed fabric) when feeding in the first depolymerization procedure is between 0.001 and 0.1. For example, the weight ratio may be between 0.005 and 0.05.

In some embodiments, the first depolymerization procedure further includes performing a heating process and/or a stirring process through an appropriate manner, wherein an execution temperature range of the heating process is between 190° C. and 210° C., and an execution time range of the stirring process is between 10 minutes and 90 minutes, but the disclosure is not limited thereto.

### <Mixing Procedure>

In some embodiments, the second particle size of the activated carbon in the mixing procedure is greater than 1 micrometer and less than or equal to 100 micrometers. For example, the second particle size may be between 2 micrometers and 75 micrometers or may be between 43 micrometers and 63 micrometers. In this way, the size of the pigment to be separated can be reliably increased to enhance the separation ability, but the disclosure is not limited thereto.

In some embodiments, an execution temperature of the mixing procedure is between 110° C. and 190° C. For example, the execution temperature may be between 120° C. and 180° C.

In some embodiments, an execution time of the mixing procedure is between 5 minutes and 90 minutes. For example, the execution temperature may be between 10 minutes and 60 minutes.

In some embodiments, a weight ratio of the activated carbon to the oligomer is between 0.005 and 0.3. For example, the weight ratio may be between 0.005 and 0.15, between 0.01 and 0.1, between 0.025 and 0.3, or between 0.05 and 0.2.

In some embodiments, a weight percentage of the activated carbon in the oligomer is between 0.5 wt % and 15 wt %, but the disclosure is not limited thereto.

In some embodiments, the mixing procedure is performed through the stirring process, and the execution time is between 10 minutes and 60 minutes, but the disclosure is not limited thereto. As long as the oligomer and the activated carbon are mixed together, the same belongs to the protection scope of the disclosure.

In some embodiments, when the heating process is used in the first depolymerization procedure, a cooling process may be performed through an appropriate manner before performing the mixing procedure, wherein the cooling process is to, for example, lower the temperature to between 120° C. and 180° C., but the disclosure is not limited thereto. When the heating process is not used in the first depolymerization procedure, no additional cooling process needs to be performed.

### <Filtration Procedure>

In some embodiments, an impurity such as the pigment is separated from the pre-depolymer containing the activated carbon through an appropriate filter, wherein a pore size of the filter is less than or equal to 1 micrometer. For example, the pore size may be less than 0.5 micrometer.

### <Second Depolymerization Procedure>

In some embodiments, an execution temperature of the second depolymerization procedure is between 180° C. and 220° C. For example, the execution temperature may be between 190° C. and 210° C.

In some embodiments, the execution time of the second depolymerization procedure is between 120 minutes and 480 minutes or may be between 150 minutes and 360 minutes.

In some embodiments, the second depolymerization procedure includes using a catalyst, wherein the catalyst includes an organic metal, and the organic metal is, for example, zinc acetate, organic titanium, organic antimony, organic aluminum, an ionic liquid, or a combination thereof.

In some embodiments, a weight ratio of the catalyst to the pre-depolymer (catalyst/pre-depolymer) when feeding in the second depolymerization procedure is between 0.0009 and 0.099. For example, the weight ratio may be between 0.0048 and 0.048. Here, 1 part of the fabric may be depolymerized into approximately 1.1 part of the oligomer.

In some embodiments, the second depolymerization procedure further includes performing a heating process and/or a stirring process through an appropriate manner, wherein an execution temperature range of the heating process is between 190° C. and 210° C., and an execution time range of the stirring process is between 150 minutes and 360 minutes, but the disclosure is not limited thereto.

In some embodiments, the second depolymerization procedure further includes using ethylene glycol, wherein a weight ratio of ethylene glycol to the pre-depolymer (ethylene glycol/pre-depolymer) when feeding is between 0 and 10 (ethylene glycol is optionally added, that is, ethylene glycol may be omitted depending on actual design requirements). For example, the weight ratio may be between 3 and 8.

Here, after performing the second depolymerization procedure, a bis(2-hydroxyethyl) terephthalate (BHET) monomer (hereinafter referred to as a BHET crude product) may be obtained, wherein the BHET crude product may contain the oligomer, but the disclosure is not limited thereto.

### <Monomer Purification Procedure>

The step of performing a purification procedure on the BHET crude product may include an operation known to persons skilled in the art, such as performing cooling crystallization (such as in an ethylene glycol phase), separating the oligomer (such as in an aqueous phase), adsorbing the impurity (such as in the aqueous phase) through an adsorbent material (for example, the activated carbon), performing cooling crystallization again (such as in the aqueous phase), and/or drying, but the disclosure is not limited thereto.

In some embodiments, in the second depolymerization procedure, in order to improve an adsorption efficiency of the adsorbent material (for example, the activated carbon) for the impurity (for example, an organic dye), a specific surface area of the adsorbent material (for example, the activated carbon) is preferably between 400 m²/g and 4,000 m²/g, and more preferably between 800 m²/g and 2,000 m²/g, but the disclosure is not limited thereto.

In addition, a pH value of the adsorbent material (for example, the activated carbon) is preferably between 4 and 7, and more preferably between 5 and 6.5, and a micropore volume thereof is preferably between 0.20 ml/g and 2.00 ml/g, and more preferably between 0.80 ml/g and 1.50 ml/g, but the disclosure is not limited thereto.

### <Polymerization Procedure>

BHET in the monomer purification procedure is polymerized. In an embodiment, the polymerization method is to polymerize into the recycled polyester (PET) fabric at a pressure of 0.2 torr to 30 torr and a temperature of 240° C. to 280° C. for 20 minutes to 120 minutes. In another embodiment, the polymerization method is to perform a first stage polymerization using a pressure of 360 torr and a temperature of 260° C. for 30 minutes, and then perform a second stage polymerization using a pressure of 0.5 torr and a temperature of 280° C. for 30 minutes, so as to obtain the recycled polyester (PET) fabric.

The following examples and comparative examples are given to illustrate the effects of the disclosure, but the claims of the disclosure are not limited to the scope of the examples.

A recycled polyester fabric produced in each example and comparative example was evaluated according to the following method.

Yield: (weight of recycled polyester fabric/weight of polyester in dope-dyed fabric)×100%.

Hue: the color space defined by the International Commission on Illumination (CIE) Lab was adopted. The Lab color space is a color-opponent space with dimension L representing brightness (referred to as whiteness of color) and a and b representing color-opponent dimensions based on nonlinearly compressed CIE XYZ color space coordinates.

Production was performed in Examples 1 to 6 in the following manner.

Corresponding to Step S110, the dope-dyed fabric shown in Table 1 was provided.

Corresponding to Step S121, the dope-dyed fabric was placed into a 1-liter three-neck glass flask, ethylene glycol and the catalyst shown in Table 1 were poured, and the heating process and the stirring process were performed at the temperature and the time shown in Table 1 to form the oligomer.

Corresponding to Step S122, the oligomer was cooled to the temperature shown in Table 1 and added to the activated carbon, and the mixing procedure was performed at the temperature and the time shown in Table 1.

Corresponding to Step S123, the filtration procedure was performed with a 1-micrometer filter to separate the pigment from the activated carbon and obtain a filtered liquid (the pre-depolymer).

Corresponding to the second depolymerization procedure of Step S130, the filtered liquid of the pre-depolymer was added to the catalyst shown in Table 1, and a heating reaction (the BHET crude product) was performed at the temperature and the time shown in Table 1. Corresponding to the monomer purification procedure of Step S130, the BHET crude

product was cooled from 195° C. to 10° C. to promote crystallization of the BHET crude product to form a solid, so that the solid could be separated and filtered from the liquid (for example, ethylene glycol). Next, 210 grams of an obtained BHET filter cake was put into a three-neck glass flask. Water and the activated carbon shown in Table 1 were then added, and then heated to 90° C. and stirred for 30 minutes. After filtering with a 5-micrometer filter, a filtrate was then cooled from 90° C. to 5° C. to perform operations such as BHET crystallization, filtration, and drying. A BHET monomer was obtained.

Corresponding to the polymerization procedure of Step S130, the BHET monomer was polymerized (the first stage polymerization was performed at a pressure of 360 torr and a temperature of 260° C. for 30 minutes, and the second stage polymerization was then performed using a pressure of 0.5 torr and a temperature of 280° C. for 30 minutes to obtain the recycled polyester fabric) to obtain the recycled polyester fabric of Examples 1 to 6 with hue and yield shown in Table 1.

TABLE 1

| | | | Example 1 | Example 2 | Example 3 | Example 4 | Example 5 | Example 6 |
|---|---|---|---|---|---|---|---|---|
| Dope-dyed | Weight (g) | | 108.7 | 108.7 | 106.3 | 106.3 | 103.4 | 103.4 |
| fabric | PET resin (g) | | 100 | 100 | 100 | 100 | 100 | 100 |
| | Pigment (carbon black) content (g) | | 8.7 | 8.7 | 6.3 | 6.3 | 3.4 | 3.4 |
| | Pigment (carbon black) particle size (micrometer) | | 0.065 | 0.065 | 0.065 | 0.065 | 0.065 | 0.065 |
| | Hue | L % | 16.4 | 16.4 | 18.3 | 18.3 | 21.4 | 21.4 |
| | | a | 1.7 | 1.7 | 1.2 | 1.2 | 0.5 | 0.5 |
| | | b | 2.8 | 2.8 | 2.2 | 2.2 | 2.7 | 2.7 |
| Pre-depolymerization | Ethylene glycol (g) | | 400 | 400 | 400 | 400 | 400 | 400 |
| step (First | Catalyst (zinc acetate) (g) | | 1.5 | 1.5 | 1.5 | 1.5 | 1.5 | 1.5 |
| depolymerization | Temperature (° C.) | | 195 | 195 | 195 | 195 | 195 | 195 |
| procedure) | Time (hr) | | 1 | 1 | 1 | 1 | 1 | 1 |
| | Oligomer weight (g) | | 110.7 | 110.7 | 112.0 | 112.0 | 115.4 | 115.4 |
| Pre-depolymerization | Activated carbon particle size (micrometer) | | 43 | 54 | 43 | 54 | 43 | 63 |
| step | Activated carbon weight (g) | | 1 | 1 | 1 | 1.2 | 0.8 | 1 |
| (Mixing procedure) | Temperature (° C.) | | 150 | 150 | 150 | 150 | 150 | 150 |
| | Time (min) | | 10 | 10 | 10 | 10 | 10 | 10 |
| Post-processing | Catalyst (zinc acetate) (g) | | 1.5 | 1.5 | 1.5 | 1.5 | 1.5 | 1.5 |
| step (Second | Temperature (° C.) | | 195 | 195 | 195 | 195 | 195 | 195 |
| depolymerization | Time (hr) | | 3 | 3 | 3 | 3 | 3 | 3 |
| procedure) | | | | | | | | |
| Post-processing | Activated carbon particle size (micrometer) | | 43 | 43 | 43 | 43 | 43 | 43 |
| step (Monomer | Activated carbon weight (g) | | 5 | 5 | 500 | 5 | 5 | 5 |
| purification | Amount of water g) | | 500 | 500 | 500 | 500 | 500 | 500 |
| procedure) | Temperature (° C.) | | 90 | 90 | 90 | 90 | 90 | 90 |
| Post-processing | Hue | L % | 61.7 | 62.3 | 63.7 | 63.9 | 62.4 | 64.2 |
| step | | a | 0.7 | 0.1 | 0.5 | 0.2 | 0.5 | 0.4 |
| (Polymerization | | b | 2.8 | 2.7 | 2.4 | 1.9 | 2 | 1.7 |

| | | | | | | | |
|---|---|---|---|---|---|---|---|
| procedure) | Yield (%) | 68.2 | 68.7 | 69.4 | 69.2 | 70.1 | 71.4 |

Production was performed in Comparative Examples 1 to 6 in the following manner.

First, a dope-dyed fabric shown in Table 2 was provided. Next, a depolymerization procedure (similar to the second depolymerization procedure without performing the first depolymerization procedure) was performed. The dope-dyed fabric was placed into a 1-liter three-neck glass flask, ethylene glycol and the catalyst shown in Table 2 were poured, and a heating process and a stirring process were performed at the temperature and the time shown in Table 2 to form a BHET crude product. Then, the BHET crude product was cooled from 195° C. to 10° C. to promote crystallization of the BHET crude product to form a solid, so that the solid could be separated and filtered from the liquid (for example, ethylene glycol). Next, 210 grams of an obtained BHET filter cake (containing 102 grams of ethylene glycol) was put into a three-neck glass flask. Water and the activated carbon shown in Table 2 were then added, and then heated to 90° C. and stirred for 30 minutes. After filtering with a 5-micrometer filter, a filtrate was then cooled from 90° C. to 5° C. to perform operations such as BHET crystallization, filtration, and drying. A BHET monomer was obtained. Finally, the BHET monomer was polymerized (the first stage polymerization was performed at a pressure of 360 torr and a temperature of 260° C. for 30 minutes, and the second stage polymerization was then performed using a pressure of 0.5 torr and a temperature of 280° C. for 30 minutes to obtain the recycled polyester fabric) to obtain the recycled polyester fabric of Comparative Examples 1 to 6 with hue and yield shown in Table 2.

TABLE 2

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Dope-dyed | Weight (g) | | 108.7 | 108.7 | 106.3 | 106.3 | 103.4 | 103.4 |
| fabric | PET resin (g) | | 100 | 100 | 100 | 100 | 100 | 100 |
| | Pigment (carbon black) content (g) | | 8.7 | 8.7 | 6.3 | 6.3 | 3.4 | 3.4 |
| | Pigment (carbon black) particle | | 0.35 | 0.35 | 0.25 | 0.25 | 0.55 | 0.55 |
| | size (micrometer) | | | | | | | |
| | Hue | L % | 16.4 | 16.4 | 18.3 | 18.3 | 21.4 | 21.4 |
| | | a | 1.7 | 1.7 | 1.2 | 1.2 | 0.5 | 0.5 |
| | | b | 2.8 | 2.8 | 2.2 | 2.2 | 2.7 | 2.7 |
| Depolymerization | Ethylene glycol (g) | | 400 | 400 | 400 | 400 | 400 | 400 |
| procedure | Catalyst (zinc acetate) (g) | | 3 | 3 | 3 | 3 | 3 | 3 |
| | Temperature (° C.) | | 195 | 195 | 195 | 195 | 195 | 195 |
| | Time (hr) | | 4 | 4 | 4 | 4 | 4 | 4 |
| Monomer | Activated carbon particle size | | 43 | 43 | 43 | 43 | 43 | 43 |
| purification | (micrometer) | | | | | | | |
| procedure | Activated carbon weight (g) | | 5 | 15 | 5 | 20 | 15 | 10 |
| | Amount of water (g) | | 500 | 500 | 500 | 600 | 700 | 800 |
| | Temperature (° C.) | | 90 | 90 | 90 | 90 | 85 | 90 |
| Polymerization | Hue | L % | 48.4 | 49.2 | 49.3 | 50.1 | 50.7 | 51.7 |
| procedure | | a | 1.1 | 1.4 | 1.7 | 1.4 | 1.7 | 1.5 |
| | | b | 4.4 | 500 | 5.4 | 5.3 | 4.8 | 3.9 |

| | | | | | | |
|---|---|---|---|---|---|---|
| Yield (%) | 43.4 | 42.7 | 45.2 | 41.7 | 39.8 | 38.4 |

From the results of Table 1 and Table 2, the following conclusion may be drawn. The recycled polyester fabric of the examples has yield of greater than 65%, and L/a/b thereof is more than 60.0%/+2.0/+4.0, so there are advantages such as good hue. However, for the recycled polyester fabric of the comparative examples, since the pigment cannot be effectively removed from the dope-dyed fabric before depolymerization (such as removing the nanoscale fine pigment through the pre-depolymerization step in the examples), the yield of the recycled polyester fabric is lower with L/a/b being 48.4%/1.1/4.4, etc., so there are shortcomings such as poor hue.

In summary, the disclosure introduces the pre-depolymerization step, so that the activated carbon with the large particle size and the pigment with the small particle size are aggregated and agglomerated. In this way, the pigment and the resin can be effectively separated through the filtration procedure, and the efficiency of the post-processing step can be increased, thereby having good performance in both yield and hue.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A manufacturing method of a recycled polyester fabric, comprising:
providing a dope-dyed fabric, wherein the dope-dyed fabric comprises a pigment and a polyethylene terephthalate resin, and a first particle size of the pigment is less than 1 micrometer;
performing a pre-depolymerization step on the dope-dyed fabric, wherein the pre-depolymerization step comprises:
performing a first depolymerization procedure on the dope-dyed fabric to form an oligomer;
adding the oligomer to an activated carbon to perform a mixing procedure, wherein a second particle size of the activated carbon is larger than the first particle size of the pigment; and
performing a filtration procedure to separate the oligomer from the activated carbon and obtain a pre-depolymer; and
performing a post-processing step on the pre-depolymer to obtain the recycled polyester fabric, wherein the post-processing step comprises a second depolymerization procedure, a monomer purification procedure, a polymerization procedure, or a combination thereof.

2. The manufacturing method of the recycled polyester fabric according to claim 1, wherein the second particle size of the activated carbon is greater than 1 micrometer and less than or equal to 100 micrometers.

3. The manufacturing method of the recycled polyester fabric according to claim 1, wherein a weight percentage of the pigment in the dope-dyed fabric is between 1 wt % and 10 wt %.

4. The manufacturing method of the recycled polyester fabric according to claim 1, wherein a weight ratio of the activated carbon to the oligomer is between 0.005 and 0.3.

5. The manufacturing method of the recycled polyester fabric according to claim 1, wherein an execution temperature of the mixing procedure is between 110° C. and 190° C.

6. The manufacturing method of the recycled polyester fabric according to claim 1, wherein an execution time of the mixing procedure is between 5 minutes and 90 minutes.

7. The manufacturing method of the recycled polyester fabric according to claim 1, wherein the first depolymerization procedure comprises using ethylene glycol and a catalyst.

8. The manufacturing method of the recycled polyester fabric according to claim 7, wherein a weight ratio of the catalyst to the dope-dyed fabric is between 0.001 and 0.1.

9. The manufacturing method of the recycled polyester fabric according to claim 1, wherein an execution temperature of the first depolymerization procedure is between 180° C. and 220° C.

10. The manufacturing method of the recycled polyester fabric according to claim 1, wherein an execution time of the first depolymerization procedure is between 5 minutes and 120 minutes.
